(19) United States
(12) Patent Application Publication
(10) Pub. No.: US 2004/0259053 A1
(43) Pub. Date: Dec. 23, 2004

(54) Method and apparatus for laser-assisted dental scaling

(76) Inventors: George I. Bekov, Pleasant Hill, CA (US); Jay A. Goble, Pleasant Hill, CA (US); Alexandre B. Di Sessa, Concord, CA (US); William R. Gianni, Concord, CA (US)

Correspondence Address: CHARLES LOUIS THOEMING, 1990 N. CALIFORNIA BLVD., SUITE 720, WALNUT CREEK, CA, 94596, US

(21) Appl. No.: 10/464,344

(22) Filed: Jun. 18, 2003

(51) Int. Cl. A61C 3/03

(52) U.S. Cl. 433/119; 433/29

(57) ABSTRACT

A novel approach to laser-assisted dental scaling methods and apparatus is presented. The invention significantly reduces risk of systemic medical health hazards to patients and dental staff resulting from bacteria contaminated aerosols produced by scaling devices. The method comprises steps for the dynamic treatment of oral sites with photosensitive agents activated by intensive laser light during dental scaling and cleaning procedures. Dual action of photodynamic therapy and intensive laser radiation enhance destruction of pathogenic microorganisms for safer dental procedures.

### CROSS-REFERENCES TO RELATED APPLICATIONS

None.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

1. Field of the Invention

The present invention relates generally to the field of dental scaling methods and apparatus, and more specifically to procedures and devices in this field employing laser radiation.

2. Description of the Related Art

A search of the prior art located the following United States patents which are believed to be representative of the present state of the prior art: U.S. Pat. No. 5,611,793, issued March 1997, U.S. Pat. No. 5,622,501, issued April 1997, U.S. Pat. No. 5,658,148, issued August 1997, U.S. Pat. No. 6,056,548, issued May 2000, U.S. Pat. No. 6,251,127 B1, issued June 2001, and U.S. Pat. No. 6,561,808 B2, issued May 2003.

### BRIEF SUMMARY OF THE INVENTION

In recent years, intensive studies have been performed on the health risk factors that periodontal disease presents on diabetes, cardiovascular disease, bacterial pneumonia, pregnancy complications, renal dialysis, postmenopausal disorders, and many others. (See, e.g., Scannapieco, F. A., and Mylotte, J. M., Relationships between periodontal disease and bacterial pneumonia, J. Periodont. 67(10) 1114-1122). Taking into account that nearly half of the adult population in the world suffer from some form of periodontal disease, the methods of effective periodontal treatment are of high importance.

Traditional methods of treatment for periodontal disease employ the use of hand-held scaling instruments in a procedure referred to as manual root-planing. Mechanical sonic or ultra-sonic scaling instruments are predominately used in conjunction with hand-held instruments for the treatment of periodontal disease. These high-energy sonic or ultra-sonic scaling devices are used in the presence of contaminated, septic bodily fluids such as blood and saliva. Utilizing high energy vibration, the instruments are designed to remove sticky dental plaques and tenacious dental calculus (tartar) from the root surface of the tooth. (See, Bennett, A. M., Fulford, M. R., Walker, J. T., Bradshaw, D. J., Martin, M. V., and Marsh, P. D. Microbal aerosol in general dental practice. Brit. Dent. J. 189, 664-667 (2000)).

The mechanical action of these instruments, operating within a diseased oral environment, poses a significant medical health risk for the patient, dental hygienist and assistant, as well as the dentist. The high-energy vibrating action dissipates an aerosol containing billions of pathogenic micro-organisms, blood, and contaminated plaques and calculus particles into the air.

Upon inhalation of the contaminated aerosols, patients and dental staff are immediately exposed to significant systemic medical health hazards. As the infected aerosol persists and settles throughout the dental office environment, often dissipated by the HVAC systems therein, it presents an additional bio-hazard to the surrounding medical equipment, reception areas and subsequent patients entering the dental facility. The entire dental office thus becomes contaminated with a fine film of septic body fluids.

The septic aerosol thus dispersed can cause severe systemic infection of the body via the respiratory system, mucous membrane lining, and by driving pathogens from scaler high-frequency oscillations into the fine blood capillary network within the walls of the tooth's surrounding periodontal pocket. Increased blood levels of periodontal pathogens introduced by the action of hand instruments, and sonic or ultra-sonic scaling devices tax the body's immune system to produce a defensive inflammatory response to this invasion of pathogenic micro-organisms. This systemic response is the crux of wide-spread medical risk factors directly related to periodontal disease.

Thus, the methods of effective disinfection/sterilization of the periodontal disease sites during treatment are of high importance to systemic medical health. So far, the most generally accepted method of oral disinfection before and during dental procedures is rinsing and irrigation of treatment sites by various medicaments. Unfortunately, this method has not proven to be effective because it is simply not physically possible for medicaments that are swished around in the mouth to come in contact with organisms that lie within plaques or infected tissues deep inside the periodontal pockets.

Implementation of lasers to treat periodontal disease during recent years has shown that laser radiation can very effectively kill bacteria within periodontal pockets. Studies have been performed using different types of lasers, both in continuous wave (“CW”) and pulsed modes. (See, e.g., Gutknecht, N, Fisher, J., Conrads, G., Lampert, F. Bactericidal effect of the Nd:YAG lasers in laser-supported curettage. Lasers in Dentistry, Proc. SPIE 2973, San Jose, Calif., 1997: 221-226; Moritz, A, Schoop, U., Goharkhay, K., Schauer, P., Doertbudak, O., Wernlech, J., and Sperr, W., Treatment of periodontal pockets with a diode laser. Lasers in Surgery and Medicine, Wiley-Liss, 22, 302-311 (1998)). In these cases, CW and pulsed mode lasers were used to disinfect/sterilize pocket sites after specific dental procedures or as separate hygiene treatments to compare bactericidal effects of laser radiation with traditional treatment methods. Although laser radiation is very effective in reducing bacterial population within the periodontal pockets, it cannot provide 100% sterilization of the treatment sites.

Another approach to improve oral hygiene and treat periodontal disease is photodynamic therapy (“PDT”). PDT implies application to treatment sites with special substances called photosensitizers, followed by their activation with a specific wavelength light. This activation produces special reactive agents, such as singlet oxygen, which enhance destruction of surrounding bacteria and germs. (See, e.g. Valduga, G., Bertoloni, G., Reddi, E., and Jori, G., Effect of extracellularly generated singlet oxigen on Gram-positive and Gram-negative bacteria. J. Photochem. Photobiol. B; Biol. 21 81-86 (1993); Chan, Y., and Lai C.-H. Bactericidal effects of different laser wavelengths on periodontopathic germs in photodynamic therapy. Lasers Med. Sci., Springer-Verlag. 18, 51-55 (2003)).

Several patents have been issued which describe use of photosensitizers (photoactivated agents) for various applications. U.S. Pat. No. 5,611,793 (Wilson, et al.) describes a topical method to disinfect or sterilize inflamed tissues, wounds and lesions in the oral cavity. The Wilson, et al., patent comprises applying a photosensitizing compound to the treatment side followed by its irradiation by suitable laser light. This one-time treatment deals with open areas such as wounds or lesions in the mouth, and the like.

U.S. Pat. Nos. 5,658,148 and 6,056,548 (Neuberger and Cecchetti) and U.S. Pat. No. 6,561,808 (Neuberger) describe dental laser cleaning devices, hygienic dental laser photo treatment methods, and methods and apparatus for oral hygiene, which are principally based on application into the oral cavity of a fluid or paste containing a photosensitizer, and subsequent irradiation of treated areas with a proper wavelength laser light or source of light in the visible spectrum to activate the photosensitizer that, in turn, initiates destruction of oral viruses and bacteria. All of these methods and apparatuses employ low-power light sources, highly diluted photosensitizers and, as such, are mainly designed for safe self-treatment and home dental hygiene care.

The need for an effective in-situ method and timely disinfection/sterilization of treated oral areas during dental scaling and cleaning effects a vast number of dental patients and dental care providers. It is an objective of the present invention to address this need. The novel inventive method and apparatus for laser-assisted dental scaling of the present invention substantially overcomes the drawbacks of disinfection methods mentioned above. The inventive method and apparatus of the present invention provide effective oral microbial decontamination during sonic/ultra-sonic scaling. Though an aerosol is created during the scaling process, it becomes sterile because a photosensitive agent activated by laser radiation produces a strong destructive effect on bacteria, viruses and other pathogens contained in the aerosol. Even when hard calculus plaques are removed from teeth surfaces, their irradiation by laser light kills bacteria on the teeth and plaque surfaces.

The method and apparatus of the present invention comprise the use of special treatment fluids, which, being deposited on teeth and gum surfaces, or into periodontal pockets before or during scaling procedures, do not effect pathogens and do not interact with oral tissues. But once photosensitive compounds contained in these dental fluids are activated by laser light of a proper wavelength, they produce very active chemical agents which provide a strong sterilizing effect on bacteria and other pathogens. This activation will be produced locally only in laser irradiated areas, and the resultant sterilizing power will depend on the laser light intensity and concentration of photosensitive compounds in the fluids. This approach allows carefully dosing medication and chemicals into the patient's oral cavity and timely removing these same chemicals and the resultant by-products, thus avoiding possible patient incompatibilities with certain medical substances.

The prior art does not disclose a dental method comprising a combination of sonic or ultra-sonic scaling and photodynamic therapy consisting of spraying the treated areas with photosensitizing fluids and activation of these fluids with a proper laser light source. The prior art does not disclose an apparatus comprising a sonic or ultra-sonic scaler, dental fluid delivery system, and a laser radiation source. The prior art does not provide a dental hand-piece comprising a sonic or ultra-sonic scaling tip, micro-spray attachment, and fiber optic delivery system positioned integrally within the same hand-piece.

It is therefore an object of the present invention to provide an new dental method and apparatus for sonic or ultra-sonic oral scaling to overcome bacterial contamination problems inherent in the prior art. Specifically, it is an object of the present invention to provide a novel method and apparatus of laser-assisted sonic or ultra-sonic scaling to disinfect/sterilize the treatment area during scaling by utilizing the scaling process spraying with photosensitizing fluid and the simultaneous activation of the treated scaling area by irradiation with a proper laser light.

Another object of the present invention is to provide an apparatus for laser assisted scaling comprising a sonic or an ultra-sonic scaler, a dental fluid delivery system, and a laser radiation source with fiber-optic delivery means.

It is also an object of the present invention to provide a novel dental hand-piece, comprising a sonic or ultra-sonic scaling tip, a fluid micro-spray means, and a fiber-optic delivery system all conveniently combined within the same hand-piece.

A preferred embodiment of the present invention discloses a novel combination of sonic or ultra-sonic scaler, dental fluid delivery system, and laser system for performing laser-assisted scaling in a bacteria-free oral environment. The laser light is generated by a laser source situated in a common housing with the fluid pump and the power supply of the scaler apparatus. The laser light is delivered to the treated area through an optical fiber system, which is included into a common hand-piece, and which has its own means for proper adjustment of laser light with respect to the end of the scaling tip. A miniature fluid pump pressurizes the tubing line, which in turn is connected to a nozzle system included in the common hand-piece. This nozzle can be adjusted by its own means with respect to the scaling tip to overlap in the treated area with laser irradiated spot. Operation of the entire systems is regulated by control means, which provide a synchronized operation of all mentioned apparatus components, as well as independent operation of the scaler, the dental fluid/water supply, laser, as well as combinations of the scaler with fluid or water, and laser with fluid supply. The system and apparatus of the present invention, or any of its subparts, can be activated or initiated by depressing a foot-switch. In the preferred embodiment of the present invention, the fluid spray and laser radiation are initiated slightly before activation of the scaler, and they continue to spray/irradiate the treated zone slightly after the moment when the scaler is deactivated. It is an advantage, and a critical feature of the present invention, to provide effective sterilization of the treatment site before, during, and after the scaling operation.

Other features, advantages, and objects of the present invention will become apparent with reference to the following description read in conjunction with the accompanying drawings.

### BRIEF DESCRIPTION OF DRAWINGS

FIG. 1A shows a top view perspective of an embodiment of a dental hand-piece comprising sonic or ultra-sonic scaler, dental fluid delivery system, and laser light fiber-optic delivery means.

FIG. 1B shows a cross-sectional view through section A-A of an embodiment of a dental hand-piece depicted in FIG. 1A.

FIG. 2 shows a block diagram of an embodiment of sonic/ultra-sonic laser-assisted dental scaling system.

### DETAILED DESCRIPTION OF THE INVENTION

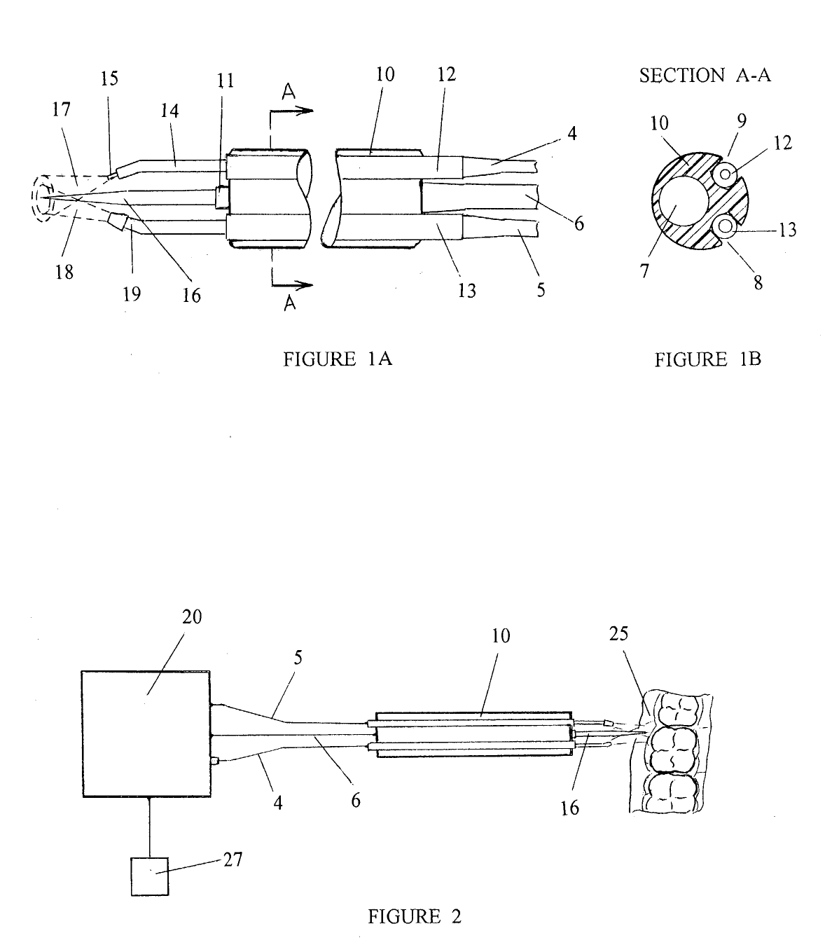

FIG. 1A depicts an embodiment of the apparatus of the present invention in which a dental hand-piece 10, having a forward or front end and a rear end, comprises a sonic or ultra-sonic scaler 11 with a scaler tip 16 end aligned with the hand-piece 10 forward or front end, a shielded fiber-optic delivery system 12, and a shielded, pressurized fluid delivery system 13.

One end of the shielded fiber-optic delivery system 12 of the hand-piece 10 terminates into miniature metal tubing 14, which comprises a delivery optical fiber 15 aligned with the hand-piece 10 forward or front end. This delivery optical fiber 15 is contained inside a connecting guard shield or cable 4, which is incorporated in the fiber-optic delivery system 12 and which serves to secure the fiber-optic delivery system 12 to the hand-piece 10. The delivery optical fiber 15 defines a laser light cone 17 when energized. The fiber-optic delivery system 12 is mounted inside a groove channel 9 in the dental hand-piece 10, and can be adjusted in the groove channel 9 longitudinally and rotationally to provide optimum irradiation of the scaler tip 16 in such a manner that the laser light cone 17 diverging from one end of the delivery fiber 15 is centered at the end of the scaler tip 16. The fiber-optic delivery system 12 comprises internal means to adjust the amount of the delivery fiber 15 protruding from the metal tubing 14 to a desired operational length. For the best results using the preferred embodiment of the present invention, this operational length of delivery fiber 15 protruding from the metal tubing 14 is from 1 mm to 4 mm.

One end of the fluid delivery system 13 of the hand-piece 10 terminates into miniature metal tubing 19 with a micro-nozzle at the tubing end, aligned with the hand-piece 10 forward or front end. This micro-nozzle sprays a special pressurized fluid containing a photosensitive agent on the scaler tip 16 and some around it in the treatment site during the scaling session. The fluid delivery system 13 is mounted inside a groove channel 8 in the dental hand-piece 10. As with the fiber-optic delivery system 12, the fluid delivery system 13 can be adjusted longitudinally and rotationally inside the groove channel 8 so that a resulting spray cone 18 is centered at the end of the scaler tip 16. Thus, the correct adjustment of the fiber-optic delivery system 12 and the fluid delivery system 13 provides overlapping of the laser light cone 17 and the spray cone 18 at the end of the scaler tip 16.

The dental hand-piece 10 comprises within its body a sonic or ultra-sonic driver 7, as depicted in FIG. 1B. This sonic or ultra-sonic driver 7 provides high-energy oscillations of the scaler tip 16. The sonic or ultra-sonic driver 7 is connected to its power and control system through a cable 6, as shown in FIG. 1A. The embodiment of the present invention depicted in FIGS. 1A and 1B, and described above, does not need internal water for proper scaling treatment since the entire hand-piece 10 contains the fluid delivery system 13.

The hand-piece can be any size and shape which conveniently fits within the operator's hand. As shown in FIGS. 1A and 1B, the hand-piece 10 body of an embodiment of the apparatus of the present invention is cylindrical, having a front, or forward oriented, end and a back end. The cylinder houses a sonic or ultra-sonic driver 7 and has two outer groove channels 8 and 9 parallel to the longitudinal axis of the hand-piece body cylinder and uniformly open along the channel length for easy removal of the shielded fiber-optic delivery system 12 and the fluid delivery system 13, respectively, for quick and easy sterilization or replacement.

FIG. 2 shows a block-diagram of the preferred embodiment of sonic or ultra-sonic laser-assisted scaling system of the present invention. A power control box 20 comprises a power supply and control means to drive the sonic or ultra-sonic scaling portion of a dental hand piece 10 through a cable 6. The power control box 20 further comprises a fluid pump and a plurality of containers for different treatment fluids. The power control box 20 also comprises a laser source producing a laser radiation of specific wavelength(s), which is delivered to the hand piece 10 through a fiber-cable 4 attached to the laser source through a standard optical connector, such as SMA 905, or the like. These connection means allow quick replacement of the fiber for sterilization or in the case of mechanical or optical system breakdown. Operation of the entire apparatus is regulated by control means, which provide a synchronized operation of all aforementioned sub-systems, as well as independent operations of scaler, dental fluid/water, laser, and combinations of sub-systems together, such as scaler with fluid delivery, scaler with laser, and laser with fluid delivery. The laser source of the preferred embodiment of the present invention can be: (i) a continuous wave (“CW”) or pulsed diode laser; (ii) an optically- or diode-pumped Nd:YAG laser; (iii) any type of DPSS laser—either CW or pulsed, including harmonic and mix-frequency generators and optical parametric oscillators; (iv) high repetition rate picosecond or femtosecond solid state, dye or gas lasers and amplifier, tunable or with a fixed wavelength. Laser radiation wavelength for the present invention should match an absorption spectrum of photosensitive agent, which is used to provide sterilization of the oral treatment site after being activated by laser radiation. The corresponding photosensitive agent is contained in the treatment fluid in the form a solution or suspension, or other chemical form suitable for delivery in a fluid.

There is a wide variety of photosensitive agents, the use of which can benefit the method and apparatus of the present invention. Most, when activated by an appropriate laser wavelength, produce hyperactive singlet oxygen which destroys bacteria. Hypercin, a clinically approved compound, is a photosensitive/photoactivated agent suitable for use in the method and apparatus of the present invention. Various applications of hypercin are described in U.S. Pat. No. 6,001,882 to Fox, et al. Hypercin is a preferred photoactivated agent because it has a broad absorption spectrum, making it ideal for use with a wide range of lasers, particularly, low-power bio-stimulation lasers in the visible spectrum. In addition, hypercin can be combined with other photo-pharmaceuticals to form compounds targeting specific bacteria, such as germs and microbes resistant to laser radiation alone. Another substance suitable for use in the method and apparatus of the present invention are polylysine residues. Polylysine can be coupled with a photo-pharmaceutical to allow a more specific targeting of harmful bacteria in the oral cavity. Some uses of polylysine residue are described in U.S. Pat. No. 6,262,030 to Wu, et al. In addition, some effective dye treatment solutions are disclosed in U.S. Pat. No. 6,251,127 to Biel.

Referring to FIG. 2, the treatment fluid containing one or more photoactivated (photosensitive) agents is delivered under pressure from the power/control box 20 via the line 4 to the hand-piece 10 for micro-spraying the treatment site 25 and the scaling tip 16. There is a particular advantage to spraying the fluid onto the treatment site 25 as opposed to soaking or irrigating the treatment site 25 with a solution before the laser treatment since blood serum, saliva, and bodily fluids of the like, cause significant degradation of photoactive agents. During spraying, the treatment site 25 always receives an unaltered portion of the agent, which is instantly activated by laser light irradiating the site. Another advantage of dispensing treatment fluid in the form of micro-spray is that the minimum quantities of chemicals are introduced into the mouth of the patient, and most of these chemicals can be removed easily by suction in timely manner thus minimizing their intake. This allows use of higher concentrations of photosensitive agents resulting in much more effective disinfection/sterilization of the treatment site 25.

Treatment in the preferred embodiment of the present invention depicted in FIG. 2 begins as a regular scaling process by bringing the scaler tip 16 in contact with the treatment site 25. A foot-switch 27 is then depressed, first activating the treatment fluid pump and the laser source. One second later, control means activate sonic or ultra-sonic drivers resulting in high-frequency oscillations of the scaler tip 16. The earlier activation of the sanitizing process kills surface bacteria before the scaling makes them air-born. Plaques and aerosol created by the scaling tip 16 are sterilized by laser radiation before they leave the laser light cone 17, indicated in FIG. 1A. Release of the foot switch first de-activates sonic or ultra-sonic action, and 0.5 second later will stop the laser action and fluid pump. This delay allows complete sterilization of all air-born particles created at the last moment of scaling.

Since many photosensitive agents are dyes, their implementation for oral site sterilization may result in some slight coloring or staining of teeth. This staining potential can be addressed by the present invention using the apparatus described above and shown in FIG. 2. One function of the control means of the power/control box 20 can be switching fluid supply from a container with photosensitive fluid to a container with hydrogen peroxide or photobleaching solution. Both of these chemicals can be applied to teeth surfaces using micro-spraying techniques of the present invention. Photobleaching solution treatment can be more selective and local than peroxide treatment since the photobleaching is activated only at the sites where laser light irradiation occurs.

Excess dental fluids or fluids and scaling/cleaning process by-products are removed during the procedure by regular suction means. Once the scaling or cleaning procedure has been completed, the treatment site and oral cavity are cleaned of any residue by application of rinsing means.

In an embodiment of the present invention, the apparatus for laser-assisted dental scaling would use a pulse diode laser operating in the spectral range of 800 to 980 nm with repetition rate of 20 to 100 Hz, an average power of 1 to 2 watts, and a pulse duration of 1 to 5 msec. Laser radiation with such parameters provides by itself a significantly strong sterilizing effect. This laser can easily be coupled with a pilot laser operating at 635 to 670 nm with output power of 5 to 10 mW. This red laser light will induce effective activation of photosensitive agents for complete sterilization of the treated site, as well as produce bio-stimulation of treated oral tissue for faster healing.

While the present invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

We claim:

1. An apparatus for laser-assisted dental scaling, comprising:
a hand-piece body;
means for scaling an oral treatment site;
means for photosensitive dental fluid delivery to the treatment site; and
means for providing laser light to the treatment site;
wherein the means for scaling an oral treatment site, means for photosensitive dental fluid delivery to the treatment site, and means for providing laser light to the treatment site are contained within the hand-piece body.

2. The apparatus of claim 1, wherein the means for scaling further comprises a sonic scaler.

3. The apparatus of claim 1, wherein the means for scaling further comprises an ultra-sonic scaler.

4. The apparatus of claim 1, wherein the hand-piece body is cylindrical, having a front end and a rear end, and further comprises two groove channels aligned parallel to the longitudinal axis of the cylinder, with each channel positioned along the outside surface of the cylinder wherein each groove channel is uniformly open along the channel length, and wherein the hand-piece front end further comprises a scaler tip.

5. The apparatus of claim 4, wherein the means for photosensitive dental fluid delivery to the treatment site further comprises a connecting shield surrounding a miniature metal tube longitudinally positioned therein, wherein the shield is sized to be adjustably positioned in one of the groove channels so that the shield can be adjusted longitudinally and rotationally within the groove channel and easily removed therefrom, wherein the shield further comprises a front end tip and a back end aligned with the hand-piece body front and back ends, wherein the shield front end terminates to expose the miniature metal tubing with a micro-nozzle at the front end tip, and wherein shield adjustment within the groove channel can be made to control the location of pressurized, photosensitive dental fluid delivery sprayed from the micro-nozzle at the treatment site and scaler tip.

6. The apparatus of claim 4, wherein the means for providing laser light to the treatment site further comprises a connecting shield surrounding a miniature metal tube longitudinally positioned therein, wherein the miniature metal tube surrounds an optical fiber longitudinally positioned and separately adjustable therein, wherein the shield is sized to be adjustably positioned in one of the groove channels so that the shield can be adjusted longitudinally and rotationally within the groove channel and easily removed therefrom, wherein the shield further comprises a front end tip and a back end aligned with the hand-piece body front and back ends, wherein the shield front end terminates to expose the miniature metal tubing with optical fiber at the front end tip, and wherein adjustment of the optical fiber within the shield can be made to control the location of laser radiation at the treatment site and scaler tip.

7. The apparatus of claim 6, wherein the laser light comprises radiation of continuous wave lasers.

8. The apparatus of claim 6, wherein the laser light comprises radiation of pulsed diode lasers.

9. The apparatus of claim 6, wherein the laser light is generated by optically- or diode pumped Nd:YAG lasers.

10. The apparatus of claim 6, wherein the laser light is generated by any type of DPSS lasers and their harmonic and mixed frequency generators and optical parametric oscillators.

11. The apparatus of claim 6, wherein the laser light is generated by high-repetition rate picosecond or femtosecond solid state, dye, or gas lasers and amplifiers, tunable or with a fixed wavelength.

12. The apparatus of claim 6, wherein the laser light carries two frequencies, comprising one frequency which is basic laser harmonic, and a second frequency which is second or third harmonic with sufficient intensity to effectively activate photosensitive agents in the dental fluid.

13. A method of laser-assisted sonic or ultra-sonic dental scaling, the method comprising the steps of:
positioning the apparatus of the present invention in close proximity to the oral treatment site;
activating a laser source to irradiate the site by laser light of specific wavelength which can be absorbed by photosensitive/photoactivated agents;
applying a special dental fluid containing photosensitive/photoactivated agents capable of absorbing laser light to the treatment site in the form of a micro-spray;
activating the photosensitive/photoactivated agents at the treatment site by the laser light source;
applying sonic or ultra-sonic scaling to the treatment site;
applying regular suction means to remove any excess of the special dental fluid and scaling byproducts; and
applying rinsing means to clean the oral treatment site of any residue.

14. The method of claim 13, further comprising the step of applying a bleaching solution to the treatment site after laser-assisted scaling to bleach any colored residues left on teeth after activating the photosensitive/photoactivated agents at the treatment site by the laser light source.

15. The method of claim 13 wherein the laser light is generated by continuous wave or pulsed diode lasers.

16. The method of claim 13 wherein the laser light carries at least two wavelengths, one wavelength which is in the visible spectrum for effective activation of photosensitive agents in the special dental fluid and all other wavelength(s) in the near-infrared spectrum region.

17. The method of claim 13 wherein the laser light is generated by optically- or diode pumped Nd:YAG lasers.

18. The method of claim 13 wherein the laser light is generated by any type of DPSS lasers and their harmonic and mixed frequency generators and optical parametric oscillators.

19. The method of claim 13 wherein the laser light is generated by high-repetition rate picosecond or femtosecond solid state, dye, or gas lasers and amplifiers, tunable or with a fixed wavelength.

20. The method of claim 13 wherein the laser light carries two frequencies, comprising one frequency which is basic laser harmonic, and a second frequency which is second or third harmonic with sufficient intensity to effectively activate photosensitive agents in the dental fluid.

21. A system for laser-assisted sonic or ultra-sonic dental scaling, comprising:
a dental hand-piece comprising a sonic or ultra-sonic scaling device with a scaling tip, means for photosensitive dental fluid delivery to an oral treatment site, and means for providing laser light to the treatment site;
a power/control box connected to the hand-piece by connecting means, and comprising a power supply and control means to drive the sonic or ultra-sonic scaling part of the hand-piece, a fluid pump, control means to deliver fluid under pressure to the hand-piece, a plurality of fluid containers, a laser source producing laser radiation of specific wavelengths, and control means to deliver laser radiation to the hand-piece; and
an operational foot-switch connected to the power/control box wherein an operator can initiate operation of hand-piece means for photosensitive dental fluid delivery to an oral treatment site, initiate operation of hand-piece means for providing laser light to the treatment site, and initiate hand-piece sonic or ultrasonic scaler action at the treatment site.

22. The system of claim 21, wherein the connecting means between the power/control box and the hand-piece further comprises shielded optical fiber, shielded pressure tested fluid conduit, and means to operate the sonic or ultra-sonic scaler contained in the hand-piece.

23. The system of claim 21, wherein the control means within the power/control box further comprises means to provide independent operation of the sonic or ultra-sonic scaling device, means for photosensitive dental fluid delivery to an oral treatment site, and means for providing laser light to the treatment site, as well as useful operational combinations of these components by the foot-switch.

24. The system of claim 21, wherein the fluid containers further comprise at least one container of a photobleaching dental solution and at least one container of photosensitizing dental fluid.

25. The system of claim 21, wherein the laser light carries two frequencies, comprising one frequency which is basic laser harmonic, and a second frequency which is second or third harmonic with sufficient intensity to effectively activate photosensitive agents in the dental fluid.
